(19) United States
(12) Patent Application Publication
(10) Pub. No.: US 2006/0009142 A1
(43) Pub. Date: Jan. 12, 2006

(54) Plant and method for the stunning and killing of animals for slaughter through asphyxiation

(76) Inventor: Bruno Cattaruzzi, Brescia (IT)

Correspondence Address: SHOEMAKER AND MATTARE, LTD, 10 POST OFFICE ROAD - SUITE 110, SILVER SPRING, MD, 20910, US

(21) Appl. No.: 10/999,122

(22) Filed: Nov. 30, 2004

(30) Foreign Application Priority Data
Jun. 25, 2004 (IT) BS2004A000075

(51) Int. Cl. A22B 3/00

(52) U.S. Cl. 452/66

(57) ABSTRACT

Plant for the stunning and/or killing of animals for slaughter, comprising a hermetically sealable chamber with an entrance aperture for the introduction of live animals and an exit aperture for removal of stunned or killed animals, closure devices to hermetically seal these apertures, and an extraction means to remove air from the chamber in order to stun or kill the animals.

### REFERENCE TO EARLIER APPLICATION

This Application incorporates by reference and claims the benefit of Italian Patent Application No. BS2004A000075, filed Jun. 25, 2004, by Cattaruzzi, entitled Plant And Method For The Stunning And Slaughter Of Animals For Through Asphyxiation.

### BACKGROUND OF THE INVENTION

1. Field of the Invention

The present invention refers to a plant and a method for the stunning or killing of farmyard animals such as chickens, turkeys, ducks, geese, pheasants, and rabbits destined for slaughter.

2. Discussion of Related Art

The methods currently used to stun and/or kill animals for slaughter include electrocution, shooting, electro narcosis, concussion and exposure to carbon dioxide.

An example of gas use to stun or kill poultry is described in patent no. EP 0 680 259 B1. This system, although advantageous for its efficiency and ability to reduce the damage which birds sometimes incur by flapping their wings, also has some inconveniences:
the presence of dangerous gas storage plants in or around the slaughterhouse;
the high construction cost of such plants, which makes their utilization difficult for small and medium sized companies;
the need to take considerable precautions in plant management, especially in the case of forced interruptions to the processing line;
loss of all animals already killed following a breakdown of the gas plant, due to the impossibility of immediate intervention inside the gas chamber;
difficulty in correct calculation of the quantity of gas to pump into the gas chamber in proportion to the animals' weight.

### SUMMARY OF THE INVENTION

The aim of the present invention is to supply a stunning and killing method with the advantageous characteristics of the systems utilizing gas but with none of the above-mentioned defects.

### BRIEF DESCRIPTION OF THE DRAWINGS

The characteristics and advantages of the plant of the invention will be more easily understood from the description below of its preferred embodiments, in conjunction with the appended indicative and non-limiting drawings, in which:

FIG. 1 illustrates a schematic view from the top of the plant in a first embodiment;

FIG. 2 shows the plant from the side;

FIG. 3 is a schematic view from the top of the plant in a second embodiment;

FIG. 4 shows the plant from the side;

FIG. 5 illustrates a schematic view from the top of the plant in a third embodiment;

FIG. 6 shows the plant in FIG. 5 from the side;

FIG. 7 shows a cross section of the plant across the line A-A in FIG. 5;

FIG. 8 is a view from the sides of the plant embodiments in FIGS. 5-7;

FIG. 9 illustrates a schematic view from the top of the plant of a fourth embodiment;

FIG. 10 shows the plant in FIG. 9 from the side;

FIG. 11 is a schematic view from the top of the plant of a further embodiment; and

FIG. 12 shows a cross section of the plant across the line A-A in FIG. 11.

### DETAILED DESCRIPTION OF THE INVENTION

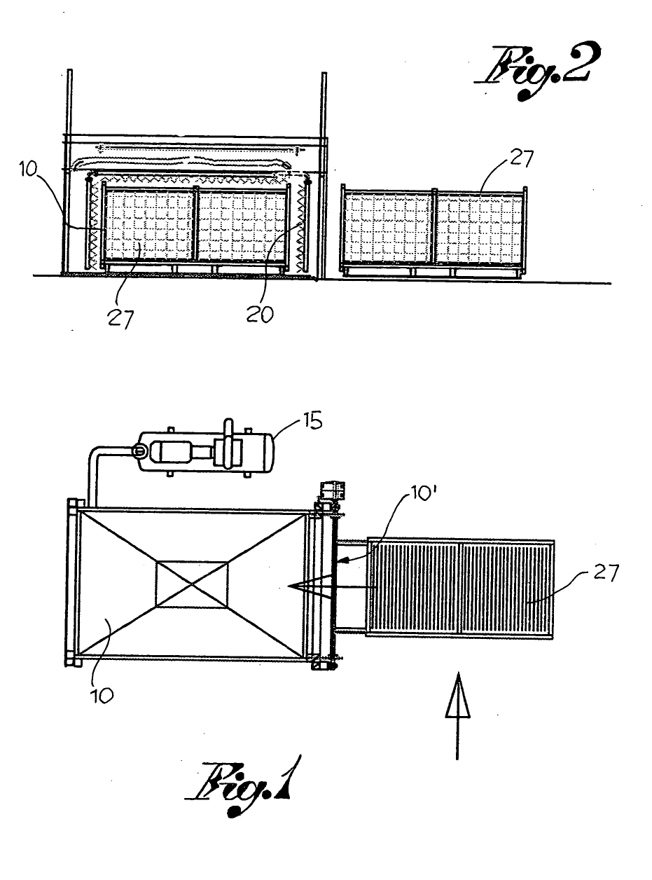

In its general embodiment, as illustrated in FIGS. 1 and 2, the stunning and/or killing plant for animals for slaughter described in this invention comprises a hermetically sealable chamber 10 with at least one aperture 10′ for introduction of live animals and removal of stunned or killed animals, devices for hermetic sealing of said aperture/s, and an extraction means 15 communicating with and extracting air from said chamber in order to stun or kill the animals.

Preferably, the chamber 10 has an entrance aperture 11 for introduction of live animals and an exit aperture 12 for removal of stunned or killed animals, each aperture having its respective closure device 13, 14.

In this case, the bottom of the hermetically sealable chamber 10 advantageously consists of a motorized conveyor 17 capable of transporting the animals from entrance 11 to exit 12. This allows the simultaneous loading of live animals into and removal of stunned or killed animals from the chamber 10.

The animals may be introduced into the plant enclosed in a single container 27, or in a succession of crates 16, or loose.

Where animal movement is in a line of crates 16 or loose, the hermetically sealable chamber is in the form of a tunnel.

Advantageously, in order to automate the phases of animal loading into the chamber 10, stunning and/or killing and removal, the live animals are transported from a loading zone (not shown) to the hermetically sealable chamber entrance aperture 12 by a motorized entrance conveyor 18. In the same way, the stunned or killed animals are transported to the exit aperture by a motorized exit conveyor.

Where the single container 27 is utilized, it can be simply inserted and removed from the chamber 10 with a lift truck.

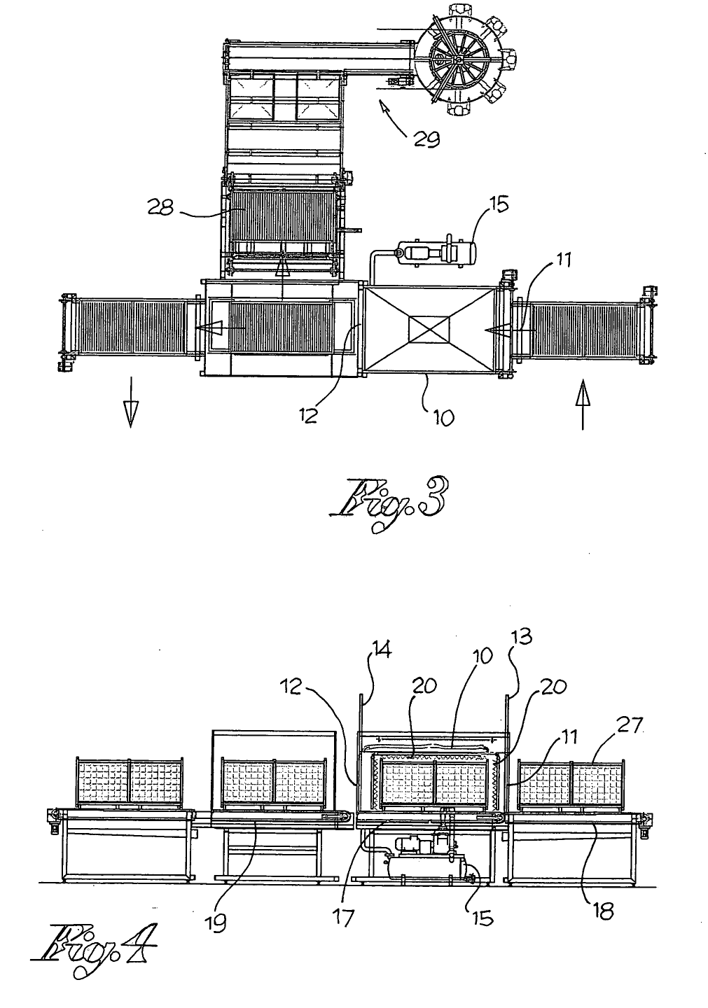

In the embodiment shown in FIGS. 1-4, for example, the hermetically sealable chamber 10 is designed to hold one or more containers 27 simultaneously. In FIGS. 3 and 4, the containers 27 are introduced into the chamber by a motorized entrance conveyor 18 and removed by the motorized exit conveyor 19. Once removed, each container 27 is activated to turn on its side to unload the killed animals onto a third motorized conveyor 28 serving a hanging line 29.

In accordance with a preferred embodiment, numerous perforated pipelines 20 connected to the extraction means 15 are positioned inside the hermetically sealable chamber 10. These perforated pipelines 20 run along the entire hermetically sealable chamber 10 and are distributed along its floor, side walls and ceiling.

The extraction means 15 comprises, for example, an electric pump connected to the perforated pipelines by a duct 15′.

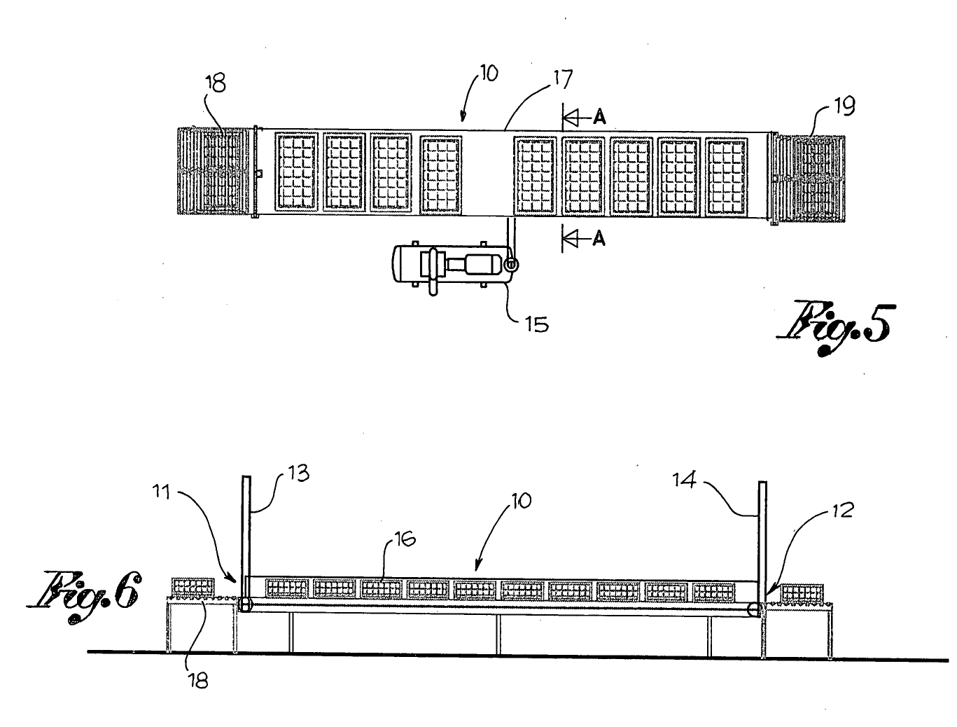

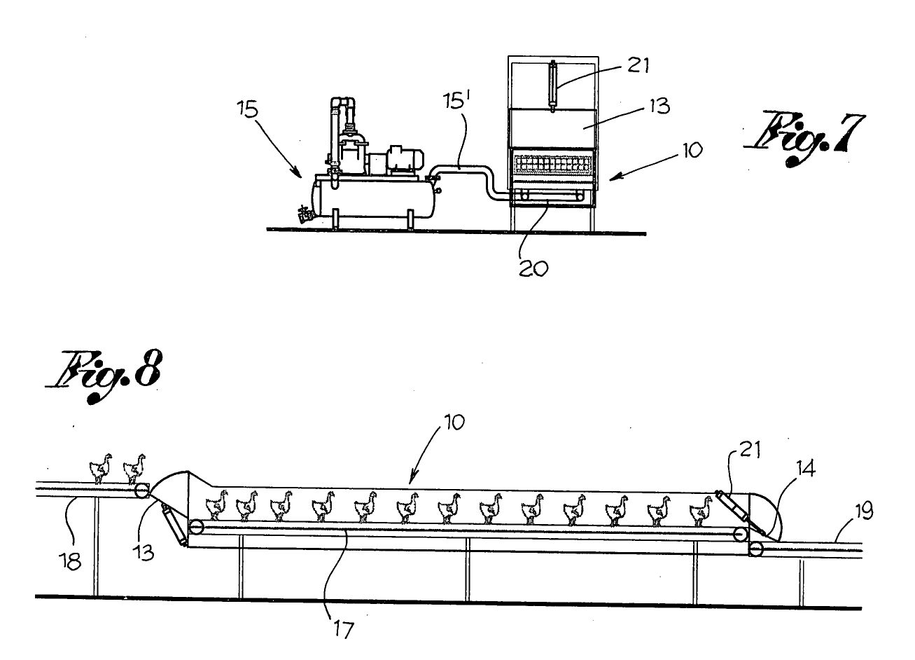

In the embodiment shown in FIGS. 1-7, the aperture closure devices 13 and 14 are in the form of a rolling shutter.

Alternatively, as shown in FIGS. 8-10, the closure devices 13 and 14 may be in the form of pivoting plates which can be activated to rotate between a raised position, or closure of apertures 11 and 12, and a lowered position, or opening of the connection between the motorized conveyors 18, 17, 19. The latter may be, for example, belt conveyors. In this case, to facilitate animal throughput, especially where they are introduced loose into the plant, the motorized entrance 18 and exit 19 conveyors are positioned respectively above and below the motorized conveyor 17 of the sealable chamber 10 (FIG. 8).

As another alternative, the entrance and exit closure devices may be of a revolving door type, allowing a continuous throughput of animals through the hermetically sealable chamber 10.

In any case, the closure devices 13, 14 are preferably actuated using electric, pneumatic or hydraulic commands.

The animal stunning and/or killing method using the above described plant thus involves the introduction of the animals into the sealable chamber 10, closure of the entrance and exit apertures and activation of the extraction means to create a vacuum within the chamber 10. Tests effected have demonstrated that a vacuum of 60 mm Hg maintained for 120 seconds will cause the death of the animals, which can then be immediately sent to the hanging area for the subsequent throat-cutting and blood draining phases. Preferably, while the stunned or killed animals are being removed from the sealable chamber 10, other live animals are simultaneously introduced into the chamber.

If required by the overall abattoir capacity, i.e. if its hourly production requires a number of animals greater than that exiting the stunning/killing plant, to avoid dead time due to the animals' stay in the sealable chamber under vacuum conditions for the pre-established time, the stunning/killing plant can be set up in such a way as to optimize loading, air extraction from the hermetically sealable chamber and removal, in order to achieve the greatest possible throughput of animals to the hanging zone.

Specifically, if N is the number of animals that the processing line after the stunning/killing plant is able to process in one unit of time, and T is the time necessary to stun/kill the animals, to enable the continuous operation of the processing line without interruption the sealable chamber must be big enough to contain at least N*T animals (ignoring for the sake of simplicity the time needed to transfer the stunned or killed animals exiting the sealable chamber to the hanging line).

In this way, there will always be stunned or killed animals ready to be supplied to the hanging line.

Nevertheless, in contrast to the plants utilized to date, the need to hermetically seal the chamber from which air is extracted means that continuous throughput of animals from the entrance to the exit of the stunning/killing by asphyxiation plant is not possible. Even in the above cited case, in which the capacity of the stunning/killing plant allows the hanging line to be re-supplied without interruptions, there is the inconvenience that the newly stunned or killed animals are not immediately hung on the processing line but wait for a time up to the time T necessary for stunning/killing. This situation may not be acceptable for correct animal processing, which requires the shortest time possible between the animal's death and its throat-cutting and blood-draining.

The following solutions to avoid this problem employ a number of hermetically sealable chambers serving the same hanging line, each one with a capacity lower than the N*T capacity defined above. These chambers can be activated independently with a temporal sequence dependent on their number and capacity. Increasing the number of hermetically sealable chambers reduces the maximum waiting time for animals to be hung on the processing line.

For example, again referring to the T and N values defined above, using two chambers each with capacity T*N/2 animals, the second chamber can be activated at T/2 time after the first is activated. The maximum waiting time for animals exiting the chamber is thus reduced from T to T/2.

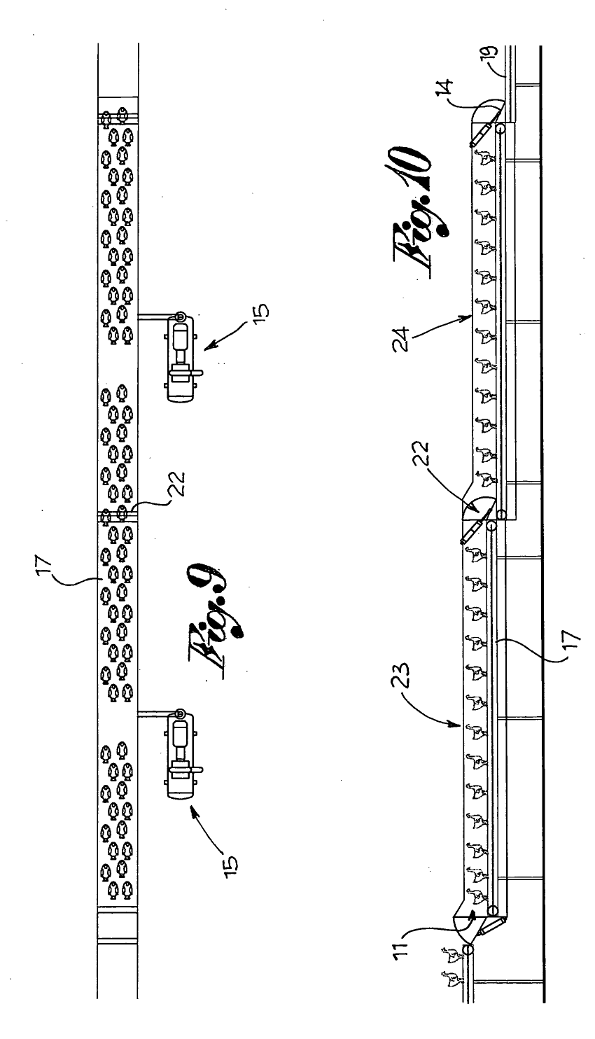

In the embodiment shown in FIGS. 9 and 10, the hermetically sealable chamber 10 is supplied with at least one intermediate closure device 22 suitable for dividing at least two compartments 23, 24, connected in cascade and hermetically separable from one another.

It is thus possible to introduce the first group of animals into the first compartment 23, close all the closure devices 13, 14 and 22 and activate the extraction means 15. After time T′ less than that necessary to stun or kill the animals, the intermediate closure device 22 is opened so that the first group of animals can be transferred to the second compartment 24. The intermediate closure device 22 is then re-closed and the entrance aperture 11 opened. A second group of animals can now be introduced into the first compartment 23 and the entrance aperture 11 closed; while the second group remains in the first compartment for time T′, the exit aperture 12 can be opened and the first group of stunned or killed animals removed. The cycle is repeated from the closure device 22 opening phase.

Such a plant allows the exit motorized conveyor 19 to be re-supplied at time intervals T′ shorter than the time T necessary for the animals' stunning or death. Obviously, increasing the number of compartments in cascade allows ever shorter waiting times to be achieved for animals exiting the stunning/killing plant.

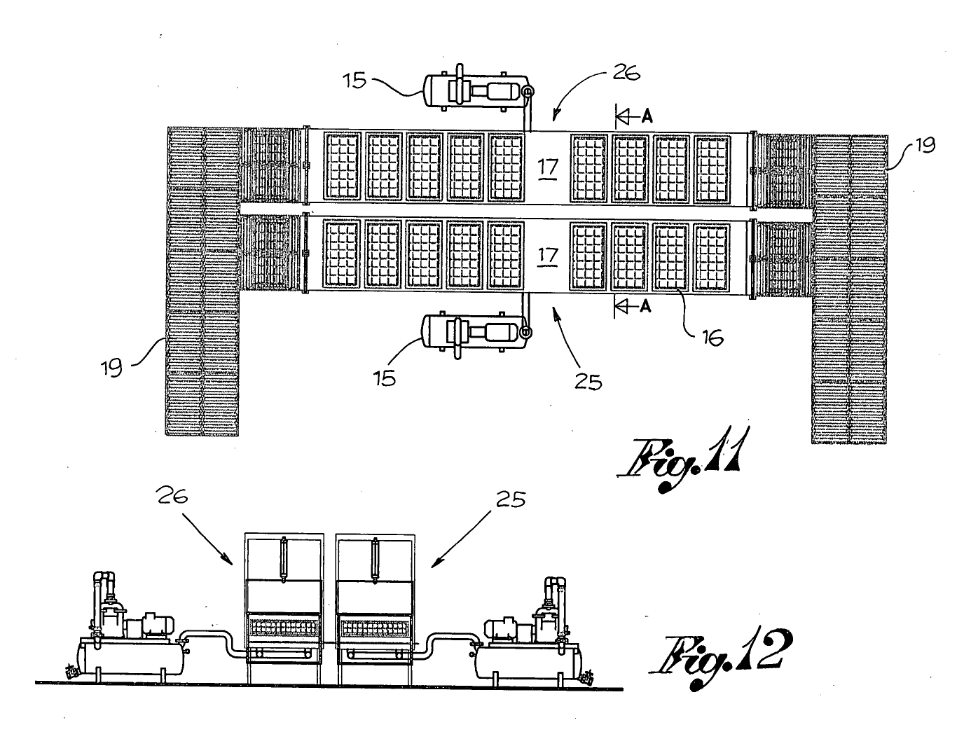

A further variant on the embodiment is shown in FIGS. 11 and 12, where the hermetically sealable chamber comprises at least two compartments 25, 26 positioned in parallel, that is with each one connected to its own extraction means 15 and having its own entrance and exit apertures with their respective closure devices.

Construction of the chamber 10 with parallel compartments allows phase initiation of successive compartments to be delayed with respect to the first, thus supplying the most continuous possible throughput of stunned or killed animals to the plant exit.

In all the embodiments described above, the plant advantageously comprises a control unit (not shown) able to activate and synchronize the extraction means, the closure devices and the motorized conveyors.

Chamber 10 capacity and conveyor speed and length are in any case chosen on the basis of the capacity of the slaughterhouse, in order to guarantee both the shortest time possible between the animal's death and its throat-cutting and blood-draining and the continuity of the processing line. In other words, the number of animals within the stunning/killing plant must be equal to or greater than the number of animals hung up on the plant line in one unit of time.

It should be noted that the described plant, as well as being financially advantageous, is also safer than plants utilizing gas. In the case of a breakdown, for example, one need only stop the pump in order to restore normal environmental conditions through a venting valve in only a few seconds, thus safeguarding both the animals in the chamber and any worker who must intervene.

Obviously, to satisfy contingent and specific requirements, a person skilled in the art could make further modifications and variations to the plant described in this invention, all however contained within the scope of the invention, as defined in the following claims.

I claim:

1. Plant for the stunning and/or killing of animals for slaughter, comprising a hermetically sealable chamber with at least one aperture for the introduction of live animals and removal of stunned or killed animals, closure devices to hermetically seal said at least one aperture, and an extraction means to remove air from said chamber in order to stun or kill the animals.

2. Plant according to claim 1, wherein said hermetically sealable chamber has an entrance aperture for introduction of live animals and an exit aperture for removal of stunned or killed animals, and in which the bottom of the hermetically sealable chamber comprises a motorized conveyor suitable for transporting the animals from the entrance to the exit apertures.

3. Plant according to claim 2, further comprising a motorized conveyor suitable for transporting live animals from a loading area to said hermetically sealable chamber.

4. Plant according to claim 3, further comprising a motorized exit conveyor suitable for transporting stunned or killed animals from said hermetically sealable chamber to an unloading area.

5. Plant according to claim 1, further comprising a number of perforated pipelines positioned inside said hermetically sealable chamber and connected to said extraction means.

6. Plant according to claim 1, wherein said extraction means comprises a pump.

7. Plant according to claim 1, wherein said closure devices are in the form of a rolling shutter.

8. Plant according to claim 1, wherein said closure devices are in the form of a revolving door to allow a continuous throughput of animals through said hermetically sealable chamber.

9. Plant according to claim 3, wherein said motorized conveyor is higher than a motorized conveyor within said hermetically sealable chamber, and an entrance aperture closure device comprises a slide, which can be activated to rotate between a closed position and an open position, wherein said motorized conveyors are connected.

10. Plant according to claim 4, wherein said motorized exit conveyor is lower than as motorized conveyor within said hermetically sealable chamber, and an exit aperture closure device comprises a slide, which can be activated to rotate between a closed position and an open position, wherein said motorized conveyors are connected.

11. Plant according to claim 1, wherein said closure devices are actionable by electrical, pneumatic or hydraulic actuators.

12. Plant according to claim 1, wherein said hermetically sealable chamber has the form of a tunnel.

13. Plant according to claim 1, wherein N is a number of animals that a processing line after said plant is able to process in a unit of time T and said hermetically sealable chamber is sized to contain at least N*T animals.

14. Plant for the stunning and/or killing of animals for slaughter, comprising a plurality of hermetically sealable chambers, wherein each of said chambers is provided with at least one aperture for introduction of live animals and removal of stunned or killed animals, closure devices to hermetically seal said at least one aperture, and an extraction means to remove air from said chamber in order to stun or kill animals, and wherein said chambers serve a slaughterhouse processing line and are independently activatable according to a sequence so as to reduce a waiting time for stunned or killed animals to exit said chambers.

15. Plant according to claim 1, wherein said hermetically sealable chamber is supplied with at least one intermediate closure device suitable for dividing at least two compartments connected in cascade and hermetically separable from one another.

16. Plant according to claim 1, wherein said hermetically sealable chamber comprises at least two compartments positioned in parallel, each having an entrance aperture and an exit aperture with respective closure devices.

17. Plant according to claim 4, further comprising a control unit able to activate and synchronize said extraction means, said closure devices and said motorized conveyors.

18. Plant for the stunning and/or killing of animals for slaughter, comprising a plurality of hermetically sealable chambers, wherein each said chamber is provided with at least one aperture for introduction of live animals and removal of stunned or killed animals, closure devices to hermetically seal said at least one aperture, an extraction means to remove air from said chamber in order to stun or kill animals, a motorized conveyor suitable for transporting the animals from an entrance aperture to an exit aperture, a motorized conveyor suitable for transporting live animals from a loading area to said hermetically sealable chamber and a motorized exit conveyor suitable for transporting stunned or killed animals from said hermetically sealable chamber to an unloading area, wherein a number and capacity of said hermetically sealable chambers and of said motorized conveyors are determined as a function of time necessary for animal loading, asphyxiation and unloading to guarantee continuity of a slaughterhouse processing line.

19. Plant for the stunning and/or killing of animals for slaughter, comprising a plurality of hermetically sealable chambers, wherein each said chamber is provided with at least one aperture for the introduction of live animals and removal of stunned or killed animals, closure devices to hermetically seal said at least one aperture, an extraction means to remove air from said chamber in order to stun or kill animals, a motorized conveyor suitable for transporting animals from an entrance aperture to an exit aperture, a motorized conveyor suitable for transporting live animals from a loading area to said hermetically sealable chamber and a motorized exit conveyor suitable for transporting stunned or killed animals from said hermetically sealable chamber to an unloading area, wherein a number and capacity of said hermetically sealable chambers and of said motorized conveyors are determined such that a number of animals within said plant is equal to or greater than a number of animals hung on a slaughterhouse processing line in one unit of time.

20. Method for stunning and/or killing of animals for slaughter using a plant according to claim 1, comprising:
introducing animals into the hermetically sealable chamber;
closing the at least one aperture;
activating the extraction means for the time necessary to stun or kill the animals within the chamber;
opening the aperture; and
removing the stunned or dead animals from the chamber.

21. Method according to claim 20, further comprising, simultaneously with said removing, introducing live animals into the chamber through an entrance aperture.

22. Method for stunning and/or killing of animals for slaughter using a plant as in claim 15, wherein the compartments are separated by an intermediate closure device, comprising:
a. introducing a first group of animals into a first compartment;
b. closing all closure devices;
c. activating the extraction means;
d. after time T′, which is shorter than that necessary to stun or kill the animals, opening the intermediate closure device so as to transfer the first group of animals to a second compartment;
e. closing the intermediate closure device and opening an entrance aperture;
f. introducing a second group of animals into the first compartment and closing the entrance aperture;
g. while the second group of animals remains in the first compartment for time T′, opening the exit aperture and removing the first group of animals;
h. repeating the cycle from step e.

23. Method for stunning and/or killing of animals for slaughter using a plant according to claim 14, comprising:
introducing animals into the hermetically sealable chamber;
closing the at least one aperture;
activating the extraction means for the time necessary to stun or kill animals within the chamber;
opening the aperture; and
removing stunned or dead animals from the chamber;
wherein the extraction means associated with each hermetically sealable chamber or compartment are activated in succession so as to supply to a plant exit a most continuous possible throughput of stunned or killed animals.

24. Method according to claim 23, in which if N is the number of animals that the slaughterhouse processing line after the stunning/killing plant is able to process in one unit of time, and T is the time necessary to stun/kill the animals, a number of animals less than N*T is introduced into each hermetically sealable chamber or compartment.

25. Method for stunning and/or killing of animals for slaughter using a plant according to claim 16, comprising:
introducing animals into the hermetically sealable chamber;
closing the at least one aperture;
activating the extraction means for the time necessary to stun or kill animals within the chamber;
opening the aperture; and
removing stunned or dead animals from the chamber;
wherein the extraction means associated with each hermetically sealable chamber or compartment are activated in succession so as to supply to a plant exit a most continuous possible throughput of stunned or killed animals.

26. Method according to claim 25, in which if N is the number of animals that the slaughterhouse processing line after the stunning/killing plant is able to process in one unit of time, and T is the time necessary to stun/kill the animals, a number of animals less than N*T is introduced into each hermetically sealable chamber or compartment.
